(19) United States
(12) Patent Application Publication
(10) Pub. No.: US 2017/0178179 A1
(43) Pub. Date: Jun. 22, 2017

(54) MODIFYING ADVERTISEMENT PRESENTATIONS

(71) Applicants: Shannon P. Bauman, San Francisco, CA (US); Brandon Pearcy, Sunnyvale, CA (US); Brian Axe, Portola Valley, CA (US)

(72) Inventors: Shannon P. Bauman, San Francisco, CA (US); Brandon Pearcy, Sunnyvale, CA (US); Brian Axe, Portola Valley, CA (US)

(73) Assignee: GOOGLE INC., Mountain View, CA (US)

(21) Appl. No.: 11/754,095

(22) Filed: May 25, 2007

(51) Int. Cl. G06Q 30/00; G06Q 30/02

(52) U.S. Cl. CPC G06Q 30/0244

(57) ABSTRACT

An advertisement presentation is generated for display to a user. The presentation may include an advertisement that is associated with an advertiser and with content requested by the user. User attention to the advertisement may be determined based on user activity. The advertisement presentation may be modified based on the determined user attention.

### FIELD

This disclosure is generally related to online advertising.

### BACKGROUND

Advertising through interactive media is gaining popularity. The Internet in particular is becoming a dominant advertising medium. Internet users often search the internet for products and services, and advertisers frequently use the Internet to target audiences interested in available products and services.

One form of Internet advertising involves distributing advertisements to online publishers for display on websites. For example, an online publisher (e.g., an online newspaper) can place brand-specific automobile advertisements for a given automobile manufacturer on a published automobile-related or other web page, in order to drive online customers to the manufacturer website. Another example of Internet advertising involves presenting advertisements in response to searches initiated by users of online searching services, such as www.google.com. In response to user queries containing keywords, such searching sites can present search results to the users as well as advertisements pertaining to the queries or results.

Users viewing online content may be directed to advertisements that relate to, but do not match, their interests. For example, a potential purchaser of an automobile part may be directed to advertisements related to automobiles generally but not advertisements related to the particular part of interest. This may occur, for example, with small advertisers who lack the financial power to have their advertisements positioned prominently on websites. Users may not find advertisements related to such advertisers even though these advertisers may offer products and services that are of particular interest to the users. In these situations, relevancy of advertisements may be compromised and the advertisements may fail to translate into real revenue.

### SUMMARY

In one general aspect, an advertisement presentation is generated for display to a user. The presentation includes an advertisement associated with an advertiser and with content requested by the user. User attention to the advertisement is determined based on user activity. The advertisement presentation is modified based on the determined user attention.

Implementations may include one or more of the following features. For example, generating the advertisement presentation may include presenting the advertisement on a portion of a web page. Generating the advertisement presentation may include presenting the advertisement in a printed publication, a television channel, and/or a radio channel.

Determining user attention to the advertisement may include determining user interest in the advertisement based on user activity and determining user satisfaction with the advertisement based on user activity associated with the advertiser. Determining user attention may include determining an amount of time a user views information associated with the advertiser and comparing the determined amount of time with a threshold value.

Modifying the advertisement presentation may include providing an option for navigating at least one additional advertisement related to the advertisement in the advertisement presentation. At least one additional advertisement may be selected from retrieved advertisements and information associated with the selecting may be tracked.

Modifying the advertisement presentation may include presenting on a user interface display scrolling interface elements that allow a user to scroll through additional advertisements related to the advertisement in the advertisement presentation. Modifying the advertisement presentation may include presenting on a user interface display at least one link that navigates to a dedicated advertising page maintained by an entity other than the advertiser. The dedicated advertising page may include additional advertisements related to the advertisement in the advertisement presentation.

Modifying the advertisement presentation may involve generating a descriptor that summarizes the content requested by a user and associating the generated descriptor with a navigation link to a web page displaying additional advertisements related to the displayed advertisement. The navigation link may be presented on a user interface display. Generating the descriptor may involve generating a phrase of one or more words that summarizes the requested content.

In another general aspect, a system includes an advertising management modules. The advertising management modules is configured to generate an advertisement presentation for display to a user. The presentation includes an advertisement associated with an advertiser and with content requested by the user. The management module is further configured to determine user attention to the advertisement based on user activity and modify the advertisement presentation based on the determined user attention.

Implementations may include one or more of the following features. For example, the advertising management module may be configured to present the advertisement on a portion of a web page. The advertising management module may be configured to present the advertisement in a printed publication, a television channel, and/or a radio channel.

The advertising management module may be configured to determine user attention by determining user interest in the advertisement based on user activity and determine user satisfaction with the advertisement based on user activity associated with the advertiser. The advertising management module may be configured to determine user attention by determining an amount of time a user views information associated with the advertiser and comparing the determined amount of time with a threshold value.

The advertising management module may be configured to modify the presentation by presenting on a user interface display scrolling interface elements that allow a user to scroll through additional advertisements related to the advertisement in the advertisement presentation.

The advertising management module is configured to modify the presentation by presenting on a user interface display at least one link that navigates to a dedicated advertising page. The dedicated advertising page may be maintained by an entity other than the advertiser. The dedicated advertising page may include additional advertisements related to the advertisement in the advertisement presentation.

The advertising management module may be configured to modify the presentation by generating one or more words that summarize the content requested by a user and associating the one or more words with a navigation link to a web page displaying additional advertisements related to the displayed advertisement. The advertising management module may be configured to present the navigation link on a user interface display.

In another general aspect, a system includes means for generating an advertisement presentation for display to a user. The presentation includes an advertisement associated with an advertiser and with content requested by the user. The system includes means for determining user interest in the at least one advertisement based on user activity and means for determining user satisfaction with the at least one advertisement based on user activity associated with the advertiser. The system further includes means for modifying the advertisement presentation based on at least one of the determined user interest and the determined user satisfaction.

In another general aspect, a computer readable medium stores a computer program. The computer program includes instructions that, when executed, cause at least one processor to generate an advertisement presentation for display to a user. The presentation includes an advertisement associated with an advertiser and with content requested by the user. Instructions cause at least one processor to determine user interest in the at least one advertisement based on user activity and determine user satisfaction with the at least one advertisement based on user activity associated with the advertiser. Instructions cause at least one processor to modify the advertisement presentation based on at least one of the determined user interest and the determined user satisfaction.

In another general aspect, a computer-implemented method includes receiving a request for advertisements from a user device. The request for advertisements includes information associated with a content presentation received by the user device. The content presentation includes a content portion having content and an advertisement portion for displaying advertisements. The method further involves providing at least one advertisement to the user device in response to the request, the at least advertisement populating the advertisement portion of the content presentation. The method involves receiving information from the user device reflecting a user interaction with the at least one advertisement. The method involves providing, to the user device, information that modifies an aspect of the advertisement portion based on the user interaction.

Implementations may include one or more of the following features. For example, the content presentation may include a web page. The web page includes the content portion having content and an HTML element for displaying advertisements. Receiving the request for advertisements may involve receiving a URL of the web page and parameters associated with the HTML element. Providing at least one advertisement may involve selecting the at least one advertisement based on the received URL.

Providing the information that modifies an aspect of the advertisement portion may involve providing a graphical user interface control, providing a selectable navigation link, and/or providing at least one additional advertisement.

In some implementations, the method may involve analyzing the user interaction information, deciding whether or not to modify the advertisement portion of the content presentation based on results of the analyzing, and determining a degree of modification for the advertisement portion, based on results of the deciding.

In another general aspect, a computer-implemented method involves sending a request for content to a publisher and receiving a content presentation from the publisher in response to the request. The content presentation includes a content portion having content and an advertisement portion for displaying advertisements. The method involves sending a request for advertisements to an advertisement server in response to receiving the content presentation from the publisher. The request for advertisements includes information associated with the received advertisement portion and information identifying the received content. The method involves receiving at least one advertisement related to the received content from the advertisement server, the at least advertisement populating the advertisement portion. The method also involves sending information to the advertisement server reflecting a user interaction with the at least one advertisement and receiving, from the advertisement server, information that modifies an aspect of the advertisement portion based on the user interaction.

Implementations may include one or more of the following features. For example, receiving the content presentation may involve receiving a web page. The web page includes the content portion having content and an HTML element for displaying advertisements.

Sending the request for advertisements may involve sending a URL of the content page. Receiving information that modifies an aspect of the advertisement portion may include receiving a graphical user interface control, receiving a selectable navigation link, and/or receiving at least one additional advertisement.

The details of one or more implementations are set forth in the accompanying drawings and the description below. Other features and advantages will be apparent from the description and drawings as well as from the claims.

### BRIEF DESCRIPTION OF THE DRAWINGS

The accompanying drawings show features of implementations consistent with this disclosure and, together with the corresponding description, help explain principles associated with the disclosure.

FIG. 1 is a block diagram depicting an exemplary advertising environment.

FIG. 2 is a diagram illustrating an exemplary data flow within an advertising environment.

FIG. 3 is a diagram of an exemplary user interface display showing exemplary advertisement presentation modifications.

FIGS. 4-6 are flow diagrams depicting exemplary advertising processes.

FIG. 7 is a flow diagram depicting an information reporting process.

FIG. 8 is a block diagram of an exemplary data processing system configuration.

FIG. 9 is a block diagram of an exemplary application layer configuration.

FIG. 10 is a block diagram of an exemplary user access device configuration.

### DESCRIPTION

The following description refers to the accompanying drawings, in which, in the absence of a contrary representation, the same numbers in different drawings represent similar elements.

### Exemplary Environment Overview

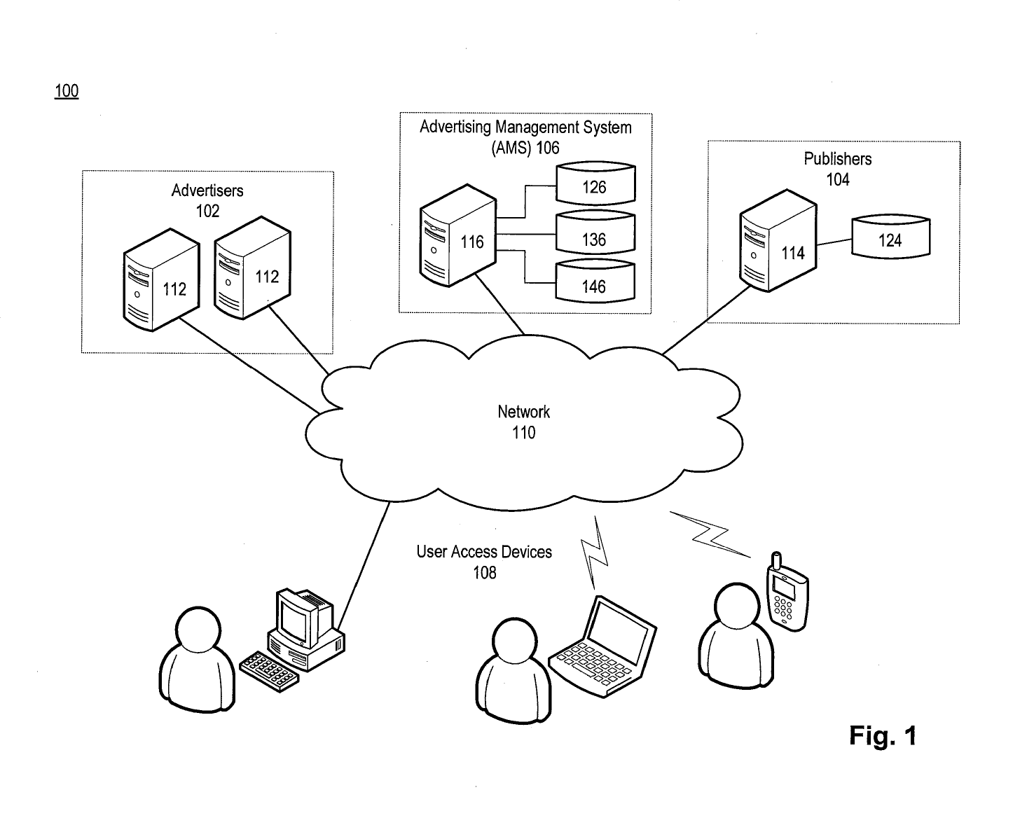

FIG. 1 is a block diagram illustrating an exemplary advertising environment 100. The environment 100 may include one or more advertisers 102, one or more publishers 104, an ad management system (AMS) 106, and one or more user access devices 108, which may be coupled to a network 110. In some examples, each of the elements 102, 104, 106, 108 and 110 may be implemented or associated with hardware components, software components, or firmware components or any combination of such components. The elements 102, 104, 106, 108 and 110 could, for example, be implemented or associated with general purpose servers, software processes and engines, and/or various embedded systems.

The advertisers 102 may include any entities that are associated with advertisements (“ads”). An advertisement or an “ad” refers to any form of communication in which one or more products, services, ideas, people, organizations or other items are identified and promoted. Ads may include communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

In some implementations, the advertisers 102 may provide (or be otherwise associated with) products and/or services related to ads. The advertisers 102 may include or be associated with, for example, retailers, wholesalers, warehouses, manufacturers, distributors, health care providers, educational establishments, financial establishments, technology providers, energy providers, utility providers, or any other product or service providers.

The advertisers 102 may directly or indirectly generate, maintain and/or track ads, which may be related to products or services offered by or otherwise associated with the advertisers. The advertisers 102 may include or maintain one or more data processing systems 112, such as servers or embedded systems, coupled to the network 110. The advertisers 102 could include or maintain one or more processes that run on one or more data processing systems.

The publishers 104 may include entities that generate, maintain, provide, present and/or otherwise process content in the environment 100. In some implementations, the publishers 104 may include content providers with an Internet presence, such as online publication and news providers (e.g., online newspapers, etc.), online service providers (e.g., financial service providers, health service provider, etc,), and the like. The term “content” refers to various types of web-based and/or other information, such as articles, discussion threads, reports, analyses, financial statements, music, video, graphics, search results, web page listings, information feeds (e.g., RSS feeds), television broadcasts, radio broadcasts, printed publications, etc. The publishers 104 may receive requests from the user access devices 108 (or other elements in the environment 100) and provide or present content to the requesting devices. The publishers may provide or present content via various mediums and in various forms, including web based and non-web based mediums and forms. The publishers 104 may generate and/or maintain such content and/or retrieve the content from other network resources.

In some implementations, the publishers 104 could provide searching services and provide content in the form of search results. A search service can receive queries for search results and retrieve relevant search results from various sources, such as an index of documents (e.g., from an index of web pages). Search results can include, for example, lists of web page titles, snippets of text extracted from those web pages, and hypertext links to those web pages.

In addition to content, the publishers 104 may be configured to integrate or combine retrieved content with ads that are related or relevant to the retrieved content for display to users. These relevant ads may be provided from the AMS 106 and be combined with content for display to users. As described further below, the user access devices 108 could also process ads for display to users. In some examples, the publishers 104 could retrieve an article for display on a particular user access device 108 and then forward the article to the user access device 108 along with code that causes one or more ads from the AMS 106 to be displayed to the user. In other examples, the publishers 104 could retrieve an article, retrieve one or more relevant ads (e.g., from the AMS 106 or the advertisers 102), and then integrate the ads and the article to form a content page for display to the user.

The publishers 104 may include or maintain one or more data processing systems 114, such as servers or embedded systems, coupled to the network 110. They may include or maintain one or more processes that run on data processing systems. In some examples, the publishers 104 may include one or more content repositories 124 for storing content and other information.

The AMS 106 may manage ads and provide various services to the advertisers 104, the publishers 106, and the user access devices 108. The AMS 106 may include one or more data processing systems 116, such as servers or embedded systems, coupled to the network 110. It could also include one or more processes, such as server processes.

In some implementations, the AMS 106 may allow elements in environment 100 to store, select and/or retrieve ads for presentation to users. For example, the AMS 106 may facilitate the distribution of ads from the advertisers 102 to the user access devices 108 via the publishers 104. The AMS 106 may also manage and process various agreements and transactions among and between elements in environment 100. For example, the AMS 106 may credit accounts associated with the publishers 104 and debit accounts of the advertisers 102.

The AMS 106 may allow the advertisers 102 to directly or indirectly, enter, maintain, and track ads for presentation on user access devices 108. In some examples, the ads may be stored in an ad repository 126. The AMS 106 may allow the advertisers 102 to select and/or specify new or existing ads as well as conversion types for ads. A “conversion” may occur when a user consummates a transaction related to a given ad. What constitutes a conversion may vary. For example, a conversion could be defined to occur when a user clicks on an ad, is referred to the advertiser's web page, and consummates a purchase there before leaving that web page. In another example, a conversion could be defined as the display of an ad to a user and a corresponding purchase on the advertiser's web page within a predetermined time (e.g., seven days). Each conversion type may correspond to a conversion action that a user may perform, such as a purchase of a product or service, a selection of a banner ad (click-through) or other action. The AMS 106 may store conversion data and other information in a conversion data repository 136.

The AMS 106 may also allow the advertisers 102 to input description information associated with ads. This information could be used to assist the publishers 104 in determining ads to publish. The advertisers 102 may additionally input a cost/value associated with selected conversion types, such as a five dollar credit to the publishers 104 for each product or service purchased.

The AMS 106 may provide ads to the publishers 104 and/or the user access devices 108. In some examples, the AMS 106 may send ads to a requesting user device 108 when the user device loads content from a particular publisher 104. The ads can be placed with or embedded in a publisher's content (e.g., videos, articles, etc.), which can be stored in the content repository 124 at the publisher, and/or placed with content received from other sources (e.g., other publishers, advertisers).

The AMS 106 may provide ads to publishers and/or user access devices such that the ads are displayed in ad presentations. An ad presentation may refer to any type of communication or display of one or more ads. The AMS 106 may present ads via various mediums and in various forms, including web based and non-web based mediums and forms. In some examples, ads may be presented in an “ad portion” of a user display. The term “ad portion” refers to any portion (which could include all) of a display in which ads can be situated. The ad portion can be a discrete, isolated portion of a display or it can be blended and dispersed throughout a display.

In some examples, the ad portion may include a portion of a web page or browser display, which also displays content. The ad portion may separate and distinct from other content in the display. For example, the ad portion could be a window or frame that is separate from displayed content. The ad portion could also be integrated and blended with displayed content. For example, the ad portion could include several sub portions dispersed throughout a web page and integrated with displayed content.

The AMS 106 may allow the publishers 104 to search and select specific products and services as well as associated ads to be displayed with content provided by the publishers 104. For example, the publishers 104 could search through ads in the ad repository 126 and select certain ads and block or filter out other ads. In some examples, the AMS 106 may contextually determine or recommend specific items and ads based on, for example, relevance to the publishers site content. The AMS 106 could also determine specific items and ads based on user behaviors, such as particular search queries performed on a search engine website, a geographical location of the user, etc. The AMS 106 could, in some examples, store user-related information (e.g., personal profiles of users, geographic locations of users, ad context information) in a general data repository 146. A combination of these and other approaches could also be used to provide ads to the publishers 104. The ad selections and preferences specified by the publishers 104 can be used by the AMS 106 when it selects ads for display to the user devices 108.

The AMS 106 may include or access one or more network searching, crawling and indexing modules (not shown). These modules may crawl the network 100 to search, identify, index and store content. The AMS 106 or another element may associate content keywords or other information with crawled content using various algorithms and logic. The content keywords may summarize aspects of the content. The AMS 106 may maintain or access an index or listing of identifiers (e.g., URLs) associated with crawled content. The identifiers may be associated with the keywords and/or other information. In some implementations, the AMS 106 may include or access a listing of URL-keyword pairings.

Using crawled and indexed network content, the AMS 106 may be configured to identify advertisements in the ad repository 126 relevant to a user's interest. The AMS 106 may be configured to compare information associated with requested content (e.g., URLs) with indexed identifiers associated with crawled content. The AMS 106 may use associated content keywords to identify and retrieve relevant ads. In some implementations, the AMS 106 could receive information (e.g., ad keywords) from the advertisers 102 relevant to the advertisers' products and services, which could be used in identifying relevant ads.

As an example, the AMS 106 can receive a URL of a requested content page (e.g., from the user access device 108 or the publisher 104). The AMS 106 may use the URL to identify the user interest (i.e., the requested content). For example, the AMS 106 may match the URL to indexed content keywords associated with the URL. The AMS 106 may then match the user interest with ads in the repository 126 relevant to the interest. The AMS 106 may use ad keywords from the advertisers 102 and/or other ad information to identify the ads. In some examples, the AMS 106 could compare ad keywords from the advertisers 102 or other information to content keywords and/or content in the content page to identify relevant ads.

In some examples, the ad preferences and selections specified by the publishers 104 and/or advertisers 102 may be used in determining relevant ads. For example, the AMS 106 may reject certain ads based on publisher preferences, even though the rejected ads may be relevant to the determined user interest.

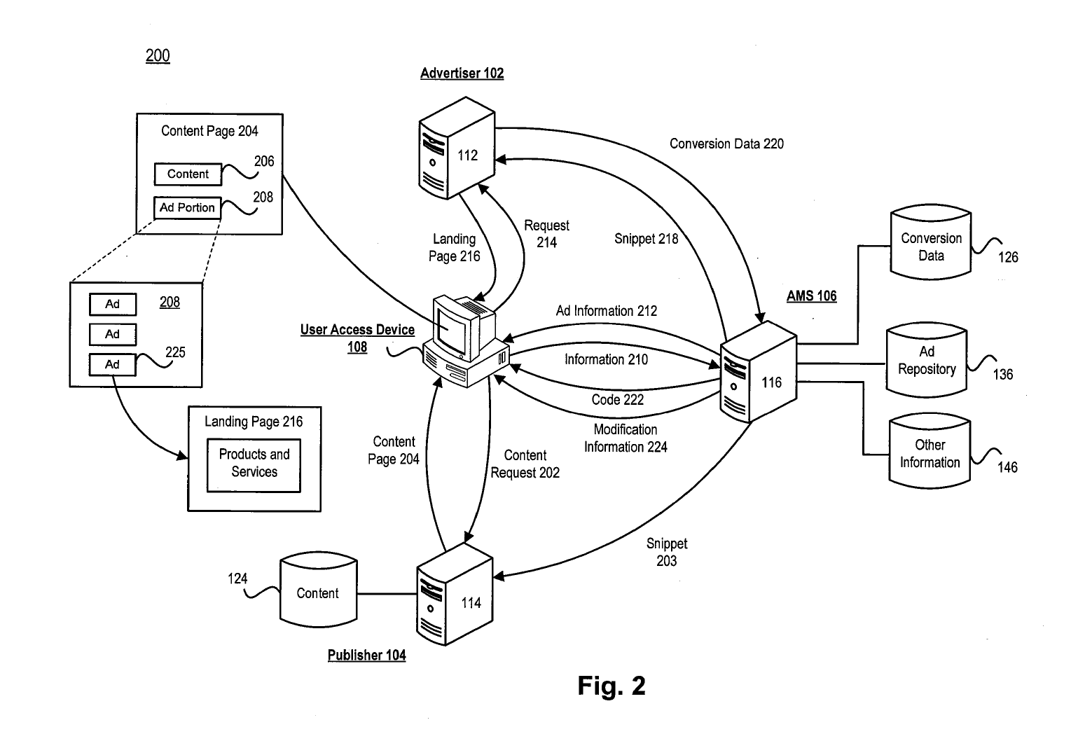

The AMS 106 may be configured to perform one or more operations and/or processes to increase the likelihood of users finding relevant ads that lead to conversions. The AMS 106 may therefore serve to increase ad relevancy and effectiveness, as well as revenues associated with ads. In some implementations, as discussed below in connection with FIGS. 2-6, the AMS 106 may modify aspects of how ads are displayed to users and/or make determinations to present new or additional ads to users. The AMS 106 could be configured to determine user attention with respect to ads displayed on the user access devices 108 and modify the presentation of ads based on the determined user attention. For example, the AMS 106 could determine user interest in a particular ad and then present one or more options to the user for viewing or navigating additional ads. In this fashion, the AMS 106 may serve to increase the likelihood of users finding relevant information and performing conversions.

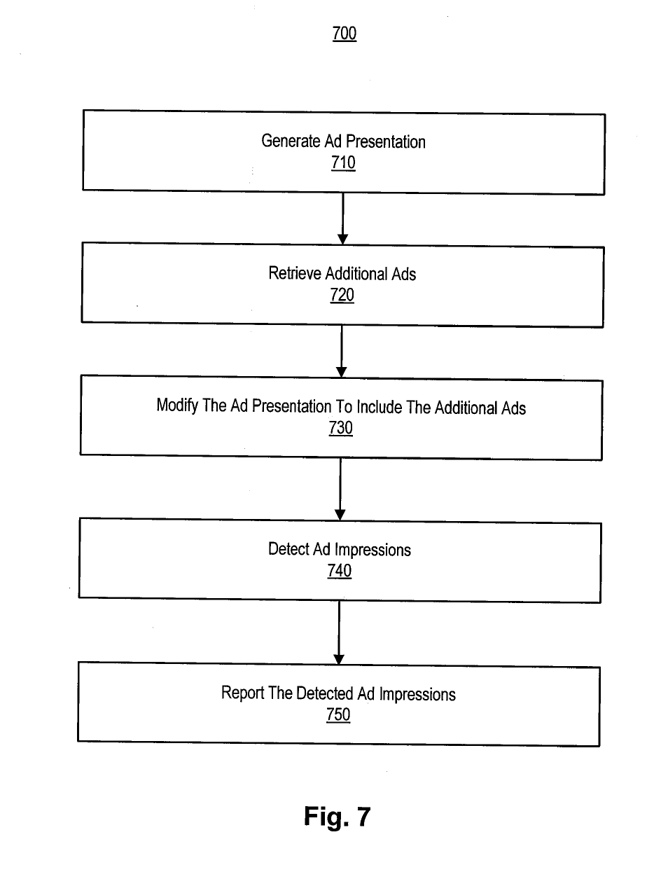

The AMS 106 may also be configured to determine and maintain information about ad impressions and report the information to other elements in the environment 100. The term ad “impression” refers to any form of presentation of an ad such that it is viewable to a user. In some examples, an ad impression may occur when an ad is displayed on a display device of a user access device. The AMS 106 may be configured to determine and maintain the number of ad impressions relative to the number of potential ads useable for presentation. The AMS 106 may also determine and maintain the ratio of the number of click-throughs to the number of impressions of the ad. The term “click-through” refers, for example, to a user selection of an ad. A “click-through” may also refer to other types of user selections. Further details of this “impressions” functionality are discussed below in connection with FIG. 7.

In some implementations, the AMS 106 may manage and process financial transactions among and between elements in the environment 100. For example, the AMS 106 may credit accounts associated with the publishers 104 and debit accounts of the advertisers 102. These and other transactions may be based on conversion data, impressions information and/or click-through rates received and maintained by the AMS 106.

The user access devices 108 may include any devices capable of receiving information from the network 110 and displaying or otherwise presenting ads. In some implementations, the user access devices 108 may receive ads and ad related information from the AMS 106 and present the ads (e.g., via a browser or other viewer) to users. The user access devices 108 may combine ads received from the AMS 106 with content received from the publishers 104 or other sources for presentation to users. Additionally or alternatively, the user access devices 108 may receive combined ads and content from the publishers 104 and present (e.g., in a viewer) this information to viewing users.

The user access devices 108 could include general computing components and/or embedded systems optimized with specific components for performing specific tasks. Examples of user systems include personal computers (e.g., desktop computers), mobile computing devices, cell phones, smart phones, media players/recorders, music players, game consoles, media centers, media players, electronic tablets, personal digital assistants (PDAs), television systems, audio systems, removable storage devices, navigation systems and the like. The user access devices 108 could also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 could include any number of geographically-dispersed advertisers 102, publishers 104 and/or user access devices 108, which may be discrete, integrated modules or distributed systems. Similarly, the environment 100 is not limited to a single AMS 106 and may include any number of integrated or distributed AMS elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes run on separate machines or a single process running on a single machine.

### Exemplary Data Flow

FIG. 2 illustrates an exemplary data flow 200 within the environment 100. The data flow 200 is exemplary only and not intended to be restrictive. Other data flows may therefore occur in the environment 100 and, even with the data flow 200, the illustrated events and their particular order in time may vary.

In the data flow 200, a particular publisher 104 may receive a content request 202 from a particular user access device 108. The content request 202 may, for example, include a request for an article on a given topic (e.g., automobiles). In response to the request 202, the publisher 104 may retrieve relevant content (e.g., an automobile article) from the content repository 124 or some other source.

The publisher 104 may then respond to the content request 202 by sending a content page 204 or other content presentation to the requesting user device 108. The content page 204 may include the requested content 206 (e.g., the automobile article) as well as a code “snippet” 203 associated with an ad presentation. A code “snippet” refers, for example, to a method used by one device (e.g., a server) to ask another device (e.g., a browser running on a client device) to perform actions after downloading information. In some examples, a code “snippet” may be implemented in JavaScript® code or may be part of HTML (Hypertext Markup Language) or other web page markup language or content.

In some implementations, the AMS 106 may provide the code snippet 203 to the publisher 104 and/or the user access device 108. The code snippet could originate and/or be provided from other sources. As the requesting user device 108 loads the content page 204, the code snippet 203 causes the user device 108 to contact the AMS 106 and receive additional code (e.g., Java Script® or the like), which causes the content page 204 to load with an ad portion 208.

The ad portion 208 may include any element that allows information to be embedded within the content page 204. In some examples, the ad portion 208 may be implemented as an HTML element, such an I-Frame (inline frame) or other type of frame. In some examples, the ad portion 208 may be hosted by the AMS 106 or the publisher 104 and may allow content (e.g., ads) from the AMS 106 or the publisher 104 to be embedded inside the content page 204. Parameters associated with the ad portion 208 (e.g., its size and shape) can be specified in the content page 204 (e.g., in HTML), so that the user access device 108 can present the content page 204 while the ad portion 208 is being loaded. Other implementations of ad portion 208 may also be used.

At this stage in the data flow 200, the ad portion 208 in the content page 204 may send the AMS 106 formatting and content information 210. This information 210 may include information describing the manner (e.g., how, when, and/or where) in which ads can be rendered by the user access devices 108. The information 210 could include ad attributes and parameters, such as size, shape, color, font, presentation style (e.g., audio, video, graphical, textual, etc.), etc. The information 210 may also specify a quantity of ads desired.

The formatting and content information 210 could also include information associated with the content 206 being displayed in content page 204. Such information may include a URL (Universal Resource Locator) associated with the requested content page 204. In some implementations, the information 210 could include the requested content itself (e.g., web page, content document, etc.), a category corresponding to the requested content or the content request (e.g., automobiles, arts, business, computers, movies, music, etc.), part or all of the content request 202, content age, content type (e.g., text, graphics, video, audio, mixed media, etc.), geo-location information, and the like.

In response to the information 210, the AMS 106 may provide the user access device 108 with ad information 212. The ad information 212 may include one or more ads 225 for placement in the ad portion 208 of the content page 204. The ad information 212 sent from the AMS 106 may also include a signed or encoded specification of an ad.

The ad information 212 may include ads that are relevant to the user's interest, as determined by the requested content. The AMS 106 may retrieve and provide relevant ads based on the information 210 received from the user access device 108. The AMS 106 may retrieve the ad information 212 from the ad repository 126, which may include ads associated with one or more advertisers 102. The AMS 106 may retrieve relevant ads using information from a crawling module, various statistical associations between ads and content, and/or preference information associated with the publishers.

After receiving the ad information 212, the ad portion 208 displayed by the user access device 108 may populate with ads included in the information 212. For example, the ad portion 208 may populate with ads 225. As illustrated in FIG. 2, the ad portion 208 and the displayed ads 225 may occupy a portion of the content page 204, which may be distinct from other content (e.g., the content 206) presented in the content page 204.

When a user clicks on the displayed ad 225 in the content page 204, an embedded code snippet may direct the user access device 108 to contact the AMS 106. During this event, the user access device 108 may receive an information parcel, such as a signed browser cookie, from the AMS 106. This information parcel can include information, such as an identifier of the selected ad 225, an identifier of the publisher 104, and the date/time the ad 225 was selected by the user. This information parcel may facilitate processing of conversion activities or other user transactions.

The user access device 108 may then be redirected to the advertiser 102 associated with the selected ad 225. The user access device 108 may send a request 214 to the associated advertiser 102 and then load a landing page 216 from the advertiser 102. The user may then perform a conversion action at the landing page 216, such as purchasing a product or service, registering, joining a mailing list, etc. An advertiser code snippet 218, which may be provided by the AMS 106, may be included within a conversion confirmation page script, such as a script within a web page presented after the purchase. The user access device 108 may execute the advertiser code snippet 218. The advertiser code snippet 218 may contact the AMS 106 and report conversion data 220 to the AMS 106. The conversion data 220 may include conversion types and numbers as well as information from cookies. In some implementations, the conversion data 220 may be maintained in the conversion data repository 136.

During data flow 200, the AMS 106 may perform one or more actions to increase the likelihood of users finding relevant ads and performing conversion actions. In some examples, the AMS 106 may modify or retarget the presentation of ads by modifying aspects of the ad portion 208. The AMS 106 may also determine user attention related to the ads 225 displayed on the content page 204 and modify the ad portion 208 based on the determined attention.

For example, if the user is not satisfied with the information on the advertiser landing page 216, the user may return to the content page 204 without performing a conversion activity. The AMS 106 may evaluate this “click-back” activity and then make a decision whether to show the user an option to view additional ads related to the ad 225. This decision may be based on an amount of time the user spent on the landing page 216 before returning to the content page 204.

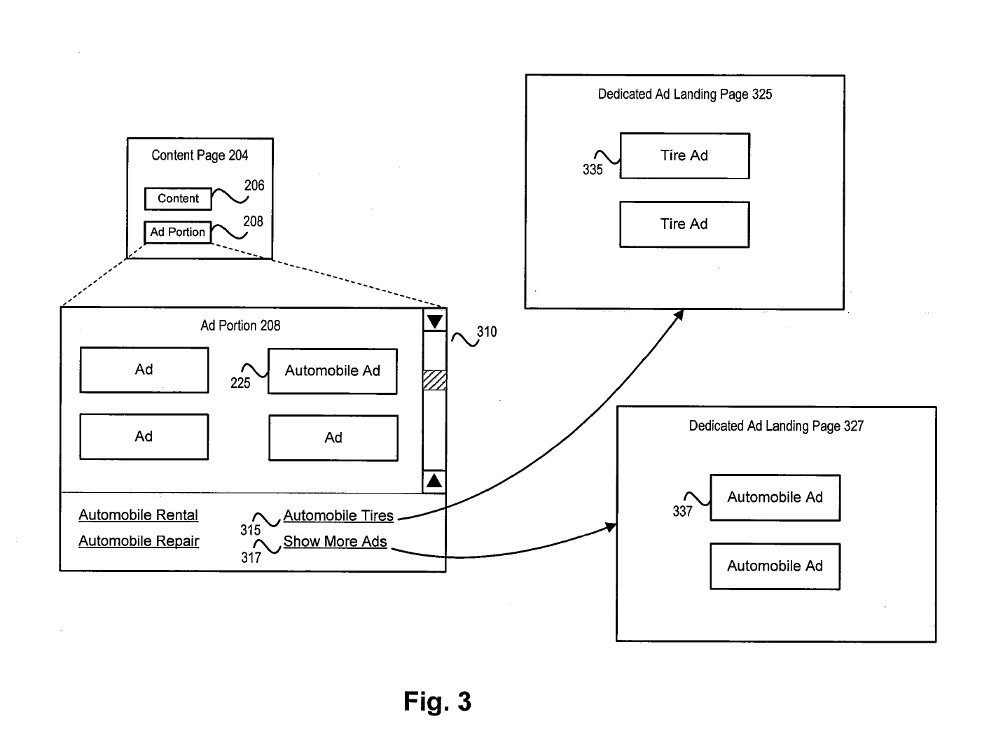

FIG. 3 illustrates exemplary modifications to the ad portion 208, which may occur during data flow 200 in order to retarget the presentation of ads. As illustrated in FIG. 3, the ad portion 208 may include one or more ads including ad 225. In this example, ad 225 could be an automobile related ad. Ad portion 208 may also include one or more user-interface elements, such as scrolling elements 310, that allow the user to navigate additional ads.

The scrolling elements 310 may allow the user to scroll from one set of ads to another set of ads. Depending on the layout of the content page 204 and the ad portion 208, the scrolling elements 310 may facilitate vertical and/or horizontal scrolling. In some examples, the scrolling elements 310 may include any type of scrolling controls, such as selectable arrows (or other) icons and/or custom scroll bar controls. Other types of user-interface elements could also be used, in addition to or instead of scrolling type elements. For example, various menus (e.g., pull-down menus, pop-up menus, etc.), buttons, radio buttons, sliders, lists, frames, windows, selection boxes, listboxes, text, graphics, etc. may be used. The user-interface elements could be static and/or dynamic (e.g., animated). The user-interface elements could include visual elements, aural elements, and even kinesthetic or physical elements.

The additional ads through which the user may scroll or otherwise navigate may be added to the content page 204 by the AMS 106. The additional ads may be related to the ad originally selected by the user (e.g., the ad 225) or the landing page (e.g., 216) associated with that ad. The additional ads may include ads that were previously retrieved by the AMS 106 in response to a request and/or may include ads subsequently retrieved by the AMS 106.

As illustrated in FIG. 3, the ad portion 208 could also include one or more topical ad links 315, such as an “Automobile Tires” link. The topical ad links 315 may include words, phrases or other representations that summarize all or a portion of the displayed content 206 of the content page 204 or topical variations related to the displayed content 206. For example, if the content 206 relates to automobiles, the ad links 315 could summarize related topical variations, such as automobile rentals, repair, and tires.

The topical ad links 315 may be operable to allow users to navigate to or through additional ads. For example, the links 315 may be associated with navigation links (e.g., hyperlinks) that direct users to one or more dedicated ad landing pages. These dedicated ad landing pages may be maintained by the AMS 106 and include additional ads related to the topics represented by the selected links. For example, when a user selects the “Automobile Tires” link 315, the user may be directed to a dedicated ad landing page 325, maintained by the AMS 106, that includes additional ads 335 related to the topic represented by the selected link—in this example, tires.

In addition to the topical ad links 315, the ad portion 208 may be modified to include a direct ad link 317, which could be labeled as “Show More Ads.” The direct ad link 317 may direct users to a dedicated landing page, maintained by the AMS 106, that includes additional ads related to the selected ad 225. For example, when a user selects the “Show More Ads” link 317, the user may be redirected to a dedicated landing page 327, which lists additional ads related to the ad 225, e.g., automobiles.

In some examples, the AMS 106 may be configured to cycle ads in response to user selections of the topical ad links 315. For example, when the user selects the “Automobile Tires” link 315, the AMS 106 could replace the existing ads in the ad portion 208 with new ads (not shown) related to the selected link 315. In some implementations, the AMS 106 may perform the cycling so that a user is presented with the new ads when the user returns to the content page 204 after viewing one or more landing pages (e.g., the dedicated ad landing page 325).

Consistent with some implementations, the AMS 106 may modify aspects of the ad portion 208 (e.g., to include the elements 310 or the links 315) based on user attention to ads. The AMS 106 may determine user attention related to the ads 225 displayed on the content page 204. For example, the AMS 106 may determine the amount of time the user spends on an advertiser landing page. The AMS 106 may also determine whether or not a conversion action is performed at the landing page and whether or not the user returns to the content page 204. The AMS 106 may modify aspects of the ad portion 208 based on this determined user attention.

Referring back to the data flow 200 of FIG. 2, the AMS 106 may determine user attention to ads by sending the user access device 108 code 222 (e.g., JavaScript®), which could automatically determine and maintain various user device and/or other information and be used to determine the amount of time spent on the landing page 216. Other techniques could also be used. For example, the user access device 108 and the AMS 106 could exchange requests and responses (not shown) related to various user activity. A combination of approaches may also be used.

Based on the determined user attention, the AMS 106 may modify or retarget the presentation of ads, which may include modifying aspects of the content page 204 including aspects of the ad portion 208. In some examples, the AMS 106 may send the user access device 108 modification information 224, which modifies aspects of the ad portion 208.

The modification information 224 may populate the ad portion 208 with additional and different ads related to the selected ad 225 and/or related to the content 206 on the content page 204. The modification information 224 may also include one more links (e.g., the links 315) to dedicated advertising landing pages maintained by the AMS 106. The modification information 224 could also include information for modifying an interface of the ad portion 208. For example, the modification information 224 could modify the ad portion 208 to include additional and/or different user interface elements, such as elements 310.

FIGS. 2 and 3 are exemplary only and not intended to be restrictive. Other data flows may therefore occur in the environment 100 and, even with the data flow 200, the illustrated events and their particular order in time may vary. Further, the illustrated events may overlap and/or may exist in fewer steps. Moreover, certain events may not be present and additional and/or different events may be included. For example, in alternative data flows, the publisher 104 could send an ad request to the AMS 106 prior to sending a content page (e.g., the content page 204) to the user access device 108. The AMS 106 may respond by sending relevant ads (e.g., the ad 225) to the publisher 104. The publisher 104 may combine the received ads with requested content in the content page 204 and then send the content page 204, including the ad portion 208, to the user access device 108 for display to a user. Other modifications to the data flow 200 are also possible.

### Exemplary Processes

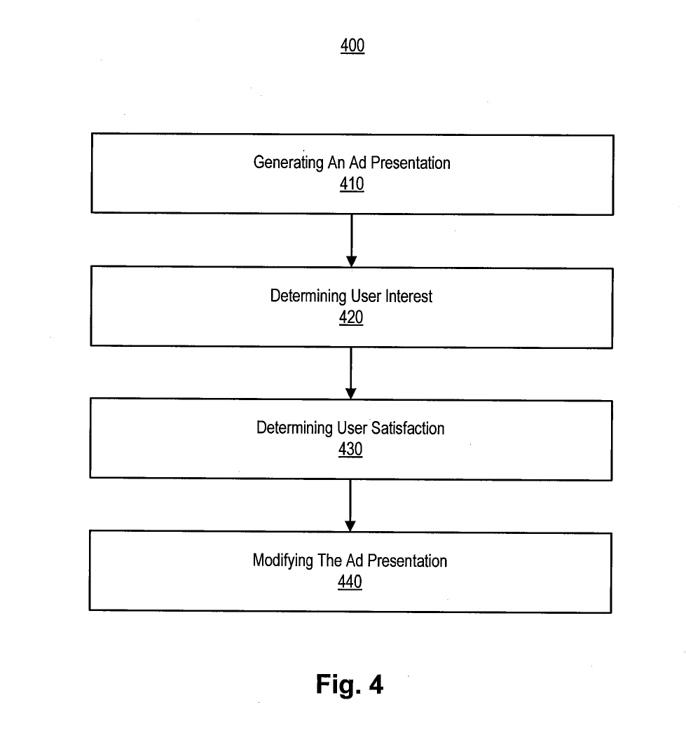

FIG. 4 is flow diagram depicting an exemplary advertising process 400 for modifying or retargeting an ad presentation. In some implementations, the process 400 may be performed by the AMS 106. The process 400 could be performed by other systems, such as the publisher 104, in conjunction with or instead of the AMS 106. The process 400 may include generating an ad presentation (410), determining user interest (420), determining user satisfaction (430), and modifying the ad presentation (440) based on the determined user interest and/or the determined satisfaction.

The process 400 may begin when an ad presentation is generated (410). The term “ad presentation” may refer to, for example, to any type of rendering of ads to a user. Generating an ad presentation could also occur when ads are audibly displayed, visually displayed, or even kinesthetically or physically displayed. In some examples, generating an ad presentation (410) may occur when the publisher 104 provides to the user access device 108 the content page 204, which includes the ad portion 208 containing various ads, such as ads 225. The content page 204 may be related to content retrieved by the publisher 104 in response to a request from a particular user access device 108.

Generating an ad presentation (410) may involve retrieving ads to populate the ad presentation. This could involve, for example, the AMS 106 retrieving ads from the ad repository 126 in response to requested content. It could also involve the publishers 104 retrieving ads from the AMS 106 or other source and/or the publishers 104 retrieving locally stored ads previously received from the AMS 106 or other source.

The process 400 may then determine user interest (420). Determining user interest may involve evaluating user interaction with the ad presentation, for example, content page 204 and the ad portion 208. In some examples, determining user interaction may include determining that the user has selected (e.g., clicked) on a displayed ad (e.g., the ad 225). Determining user interest may also involve evaluating other user selections as well as a number of selections made by a user. In some examples, determining user interest may involve generating and providing code to the user access devices 108 (or some other network element).

In some implementations, determining user interest (420) could include determining that a user has interacted with a displayed ad without visiting a landing page. That is, the determining (420) could determine some user interaction with an aspect of the displayed ad 225 that does not result in the user being redirected to the landing page 216. For example, the determining could detect cursor movement in or near the ad portion 208 and/or movement over or near the displayed ad 225.

Determining user interest (420) could also involve analyzing historical information. For example, the determining could involve determining user preferences (e.g., pages visited, ads selected, etc.) and determining user interest in a particular product, service, and/or ad based on past preferences.

The process 400 may also determine user satisfaction (430). In some examples, determining user satisfaction may involve determining that the user was not presented with ads relevant to the user's interest. Determining user satisfaction may include determining that the user selects an ad (e.g., the ad 225) from the ad presentation (e.g., the ad portion 208) and investigates the advertiser (e.g., visits the advertiser landing page 216) but then returns to the ad presentation without performing a conversion action. Determining user satisfaction could include various other actions, such as analyzing historical information, user preferences and/or analyzing website data. Determining user satisfaction could also include obtaining satisfaction information directly from a user, for example, by presenting an inquiry to the user.

For clarity of explanation, FIG. 4 depicts determining user interest (420) and determining user satisfaction (430) as separate elements. All or portions of the functionality associated with these elements, however, could overlap. Moreover, these elements could be represent aspects of more general functionality for determining user attention to ads. That is, process 400 could involve determining user attention to ads, which may include functionality associated with determining user interest (420) and/or determining user satisfaction (430).

The process 400 may modify the ad presentation (440) based on at least one of the determined user interest and the determined user satisfaction. Modifying the ad presentation may involve performing any activity that could increase the likelihood of the user finding an ad that results in a conversion action. In some implementations, modifying the ad presentation (440) may involve modifying the content page (e.g., the content page 204) containing the originally selected ad (e.g., the ad 225) using various techniques.

One modification technique involves modifying the ad presentation to include a set of user-interface elements that allow the user to navigate from one set of ads to another set of ads. For example, as illustrated in FIG. 3, the content page 204 could include one or more scrolling elements (e.g., the elements 310) that allow the user to scroll through additional ads. Other types of user-interface elements could also be used, such as static or dynamic menus, buttons, sliders, lists, boxes, and the like. The user-interface elements could include visual elements, aural elements, and even kinesthetic or physical elements.

Another modification technique involves presenting to the user one or more links (e.g., the links 315 and 317) or other options for viewing additional ads related to a previously selected ad or related to requested content. These additional ads may be displayed at one or more dedicated ad locations (such dedicated ad landing pages 325 and 327), which could be maintained, for example, by the AMS 106. Other modification techniques may involve cycling through ads. This may involve cycling out old ads and replacing them with new ads, which may be related to various user selections (e.g., an ad selection).

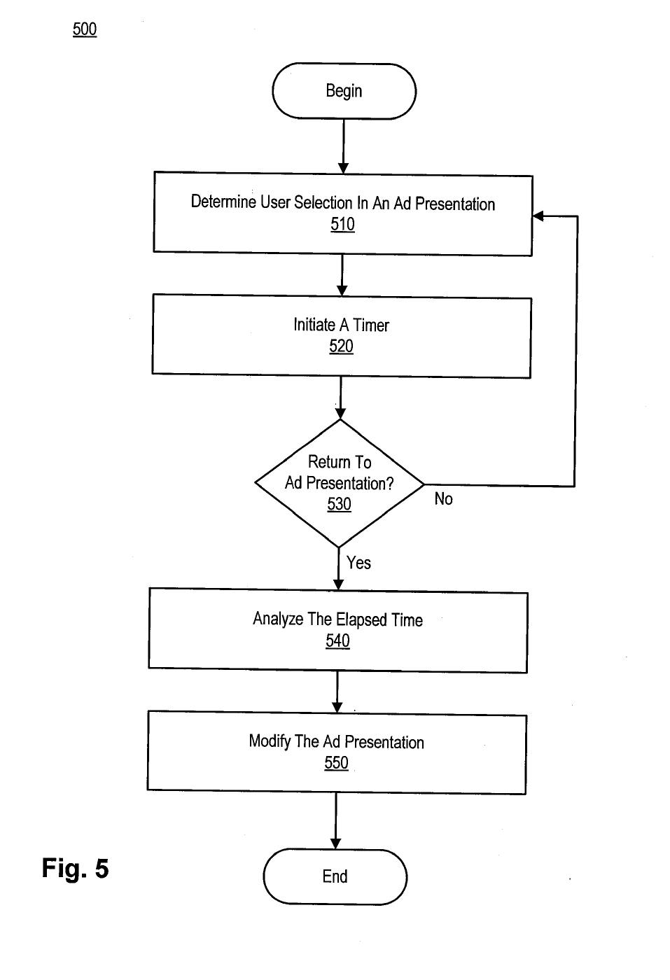

FIG. 5 illustrates another exemplary advertising method 500 for modifying or retargeting an ad presentation. As with the process 400, the process 500 may be performed by the AMS 106. The process 500 could be performed by other systems, such as the publisher 104, in conjunction with or instead of the AMS 106.

The process 500 may determine a user selection in an ad presentation (510). This may involve, for example, determining a user selection of the ad 225 from the ad portion 208 of the content page 204. The process 500 may then initiate a timer (520). This could be implemented, in some examples, using a software-based timer. For example, the determining may include providing code (e.g., JavaScript® or the like) to the user access devices 108 or other network element. Other implementation techniques could also be used.

The process 500 may determine whether the user returns to the ad presentation after selecting the ad (530). For example, this decision may involve determining whether a user returns to the content page 204 after viewing the advertiser landing page 216 associated with the selected ad 225. If the user does not return to the ad presentation (530), then the process 500 may continue to determine additional user selections (510) or, alternatively, it may terminate.

If the user returns to the ad presentation (530), then the process 500 may analyze the elapsed time (540). For example, the process 500 may analyze the amount of time the user spent at the advertiser landing page before returning to the content page that directed the user to the landing page. Analyzing the elapsed time may involve comparing the elapsed time to various thresholds.

In some implementations, the analyzing (540) may involve making assumptions about user interest based on the elapsed time and deciding whether or not to perform a modification based on the elapsed time. For example, if a user selects an ad and then browses an advertiser landing page for three seconds before returning to the content page, the process 500 may assume that there was little or no interest in the landing page or the associated advertiser.

If the user selects an ad and then spends a more significant amount of time on the landing page 216 (e.g., 10 seconds, 15 seconds, 30 seconds, 60 seconds, etc.) before returning to the content page, then the process 500 may assume that there was some interest in the landing page and/or the associated advertiser. Different time thresholds may trigger different interest assumptions. For example, 15 seconds may indicate a low interest and 30 seconds may indicate a medium interest.

Using the assumptions about interest, the process 500 may decide whether or not to perform a modification to the ad presentation. For example, if the user spends two seconds on an advertiser landing page, the process 500 may assume that the user is not interested in viewing additional ads related to the selected ad. Using this assumption, the process 500 may decide not to modify the ad presentation. In another example, the user may spend 30 seconds on the advertiser landing page. In this case, the process 500 may decide that a modification to the ad presentation would be appropriate.

The process 500 may also determine a degree or level of modification to perform. For example, if the user interest is assumed to be low, a first level of modification could be determined. If the user interests is determined to be medium or high, a second level of modification may be applied.

Using results of the analysis (540), the process 500 may modify the ad presentation (550). The may involve modifying the ad portion 208 of the content page 204 to include a set of user-interface elements (e.g., the elements 310) that allow the user to scroll through additional ads. Modifying the ad presentation (550) may also involve presenting to the user one or more selectable links (e.g., the links 315 and 317) for viewing additional ads related a previously selected ad, related to advertisers and advertiser landing pages, and/or related to requested content on a content page. These additional ads may be displayed at one or more dedicated ad landing pages (such as the pages 325 and 327), which could be maintained, for example, by the AMS 106. Modifying the ad presentation (550) may also involve cycling through ads. This may involve cycling out ads from the ad portion of a content page and inserting new ads related to the user selections.

In the process 500, the modifying (550) may include selecting and performing different modifications based on the determined user interest. For example, user-interface elements may be added in response to a low user interest and topical links may be added in response to a high interest. In other examples, a single topical link could be added in response to a low user interest and multiple topical links could be added in response to a high user interest. Of course, other variations and techniques are also possible.

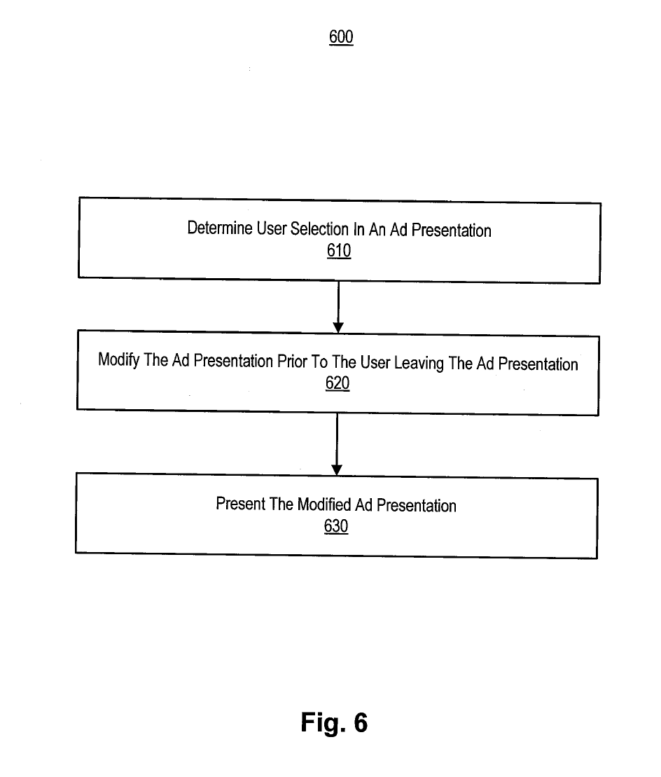

FIG. 6 illustrates another exemplary advertising process 600 for modifying an ad presentation. In some examples, the process 600 may be used to modify ad presentations when the amount of time a user spends at an advertiser landing page before returning to a content page cannot be analyzed. The process 600 may be performed by the AMS 106. The process 600 could be performed by other systems, such as the publisher 104, in conjunction with or instead of the AMS 106.

The process 600 may determine a user selection in an ad presentation (610). This may involve, for example, determining a user selection of the ad 225 from the ad portion 208 of the content page 204. The process 600 may modify the ad presentation prior to the user leaving the ad presentation (620). For example, the process 600 may modify aspects of the ad portion 208 of the content page 204 prior to the user being redirected from the content page 204 to an advertising landing page (e.g., the landing page 216).

Modifying the ad presentation (620) may involve performing one or more modifications similar to those described above in connection with elements 440 and 550 of FIGS. 4 and 5. Modifying the ad presentation (620) may involve, for example, modifying the content page to include a set of user-interface elements (e.g., the elements 310) that allow the user to scroll through additional ads. Modifying the ad presentation (620) may also involve presenting to the user one or more selectable links (e.g., the links 315 and 317) for viewing additional ads related a previously selected ad, related to advertisers and advertiser landing pages, and/or related to requested content on a content page. Modifying the ad presentation (620) may involve cycling out ads from the ad portion of a content page and inserting new ads related to the user selections.

The process 600 may then present the modified ad presentation (630) to the user. This may involve detecting that the user returns to the content page 204 from the advertiser landing page (e.g., the landing page 216) and presenting various modifications to ad portion 208 of the content page 204.

FIG. 7 illustrates an exemplary process 700 for processing ad impressions. The process 700 may be performed by the AMS 106. The process 700 could also be performed by other systems.

The process 700 may begin when an ad presentation is generated (710). This may involve presenting the ad portion 208 in the content page 204 to a user. The ad portion 208 may include a displayed ad, such as the ad 225. The process 700 may then retrieve or fetch additional ads (720) for display to the user. This may occur, for example, in response to determined user interest and/or determined user satisfaction (e.g., stages 420 and 430) and/or in response to a user selection of an ad from the ad presentation (e.g., stage 610). Retrieving additional ads (720) may involve the AMS 106 retrieving or fetching additional ads from the ad repository 126. Retrieving additional ads (720) could also involve the publishers 104 retrieving additional ads from the AMS 106 or other source and/or the publishers 104 retrieving locally stored ads previously received from the AMS 106 or other source.

The process 700 may modify the ad presentation to include the retrieved additional ads (730). Modifying the ad presentation (730) may involve, among other things, modifying the ad presentation to allow a user to navigate through the retrieved additional ads. The modifying may involve performing modifications similar to those described above in connection with element 550 of the process 500. For example, the modifying (730) could include modifying the ad presentation to include a set of user-interface elements (e.g., the elements 310) that allow the user to scroll through the additional ads.

The process 700 may then detect ad impressions (740). This may involve detecting presentations of the retrieved additional ads. For example, if two additional ads are retrieved and presented in a modified ad presentation, the detecting (740) may detect an ad impression for each additional ad. Detecting impressions (740) may also involve detecting the lack of ad impressions (i.e., potential impressions). That is, the detecting could detect that an ad has not been presented.

In some implementations, detecting impressions (740) could involve detecting “delayed” impressions of retrieved ads. That is, the detecting could involve detecting impressions of ads that are available for presentation but not initially presented. As an example, the retrieving (720) could yield five additional ads (e.g., Ad-1, Ad-2, Ad-3, Ad-4, and Ad-5). The ad presentation (e.g., ad portion 208) could be modified so that some of those additional ads (e.g., Ad-1, Ad-2) are initially presented while the remaining additional ads (e.g., Ad-3, Ad-4, Ad-5) are viewable when the user navigates through the presentation using a scroll or other user-interface control (e.g., the elements 310). In this example, detecting ad impressions (740) may involve detecting if and when any of those remaining additional ads not initially presented (e.g., Ad-3, Ad-4, Ad-5) are presented. For example, the detecting may involve detecting when a user activates a scroll or other user-interface control to cause the remaining ads (e.g., Ad-3, Ad-4, Ad-5) to be displayed. If any of the remaining ads (e.g., Ad-3, Ad-4, Ad-5) are not presented to the user, the detecting (740) may detect this information as well. In this fashion, the process 700 may serve to track delayed impressions of retrieved ads.

In some examples, detecting ad impressions (740) may involve determining and maintaining the ratio of ad impressions to potential impressions. It may also involve determining and maintaining the ratio of the number of click-throughs associated with a particular ad to the number of impressions of that ad. Detecting ad impressions could also involve determining and maintaining various other ratios, metrics, parameters, performance indicators and the like.

The process 700 may then report the detected ad impressions (750), which may include reporting information associated with detected impressions. This could involve reporting that an ad was presented to and/or selected by a user. The reporting (750) could also involve reporting that an ad was retrieved but not presented and/or selected. The reporting (750) could involve the publishers 104 reporting impressions information to the AMS 106 and/or the AMS 106 reporting impressions information to the publishers 104, the advertisers 104 and/or another entity. In some implementations, the reporting (750) could involve routing information with a given system. For example, the reporting could involve the AMS 106 routing impressions information from one AMS component or related system to another AMS component or related system. The reported ad impressions information may be used to facilitate various performance analyses and/or financial transactions. In some examples, the impressions information could be used in crediting accounts associated with the publishers 104 and debiting accounts of the advertisers 102.

FIGS. 4-7 are consistent with exemplary implementations. The sequences of events in FIGS. 4-7 are exemplary and not intended to be limiting. Other processes may therefore be used and, even with the processes depicted in FIGS. 4-7, the illustrated events and their particular order in time may vary. Further, the illustrated events may overlap and/or may exist in fewer steps. Moreover, certain events may not be present and additional events may be included in the illustrated processes.

### Exemplary Data Processing System Configuration

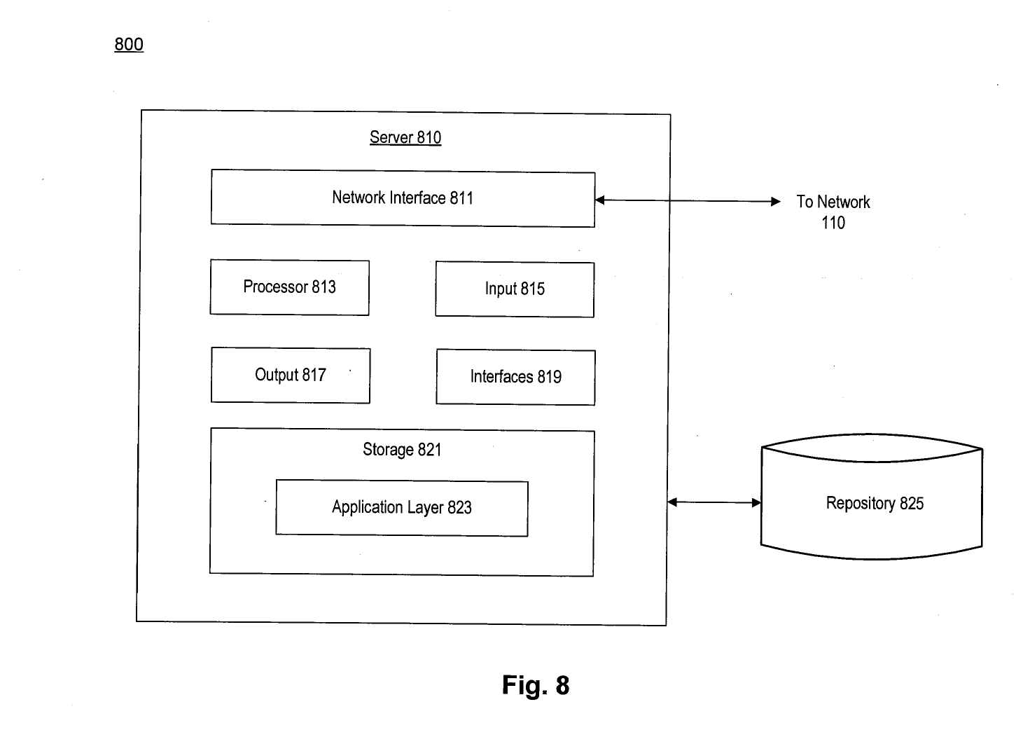

FIG. 8 illustrates an exemplary configuration 800 of an exemplary server system 810. In some implementations, the data processing systems 112, 114 and 116 depicted in FIG. 1 could be configured in a manner consistent with configuration 800. The configuration 800 is exemplary only, and the systems 112, 114 and 116 could be configured in other ways. Further, each of the servers could have its own individual structure and configuration. Moreover, as noted above, the functions provided by the systems 112, 114 and 116 could be performed by a single server computer or could be performed by a single server process running on a single computer.

In the configuration 800, the server 810 may include various components, such as a network interface 811, a processor 813, an output 815, an input 817, interfaces 819, and a storage 821. One or more system buses (not illustrated) may interconnect these components. The number, identity and arrangement of elements in the configuration 800 are not limited to what is shown, and additional and/or different elements may be contained in or coupled to the elements shown. Further, configuration 800 may include fewer components than what is illustrated.

The network interface 811 may facilitate connectivity with a network, such as the network 110. Network interface 811 may be any appropriate wireline (e.g., IEEE® 1394, USB, etc.) or wireless (e.g., IEEE® 802.11, Bluetooth®, IrDA®, etc.) mechanism for facilitating unidirectional or bidirectional transmission of data between the server 810 and a network. The network interface 811 may include one or more network cards and/or data and communication ports.

The processor 813 routes information among components and executes instructions from storage 817. Although FIG. 8 illustrates a single processor, the server 810 may include any number of general- and/or special-purpose processors. The processor 813 may be implemented, for example, using one or more commercially available INTEL® processors.

The output 815 may present text, images, video, audio, or any other type of information. Examples of the output 815 include, video display devices, audio display devices, printers, and the like. The output 815 may display user interface information for various software applications running on the server 810, as well as the operating system programs necessary to operate the system. The output 815 may present information by way of a cathode ray tube, liquid crystal, liquid crystal on silicon, light-emitting diode, gas plasma, laser, or other type of display mechanism. The output 815 could also be configured to receive, generate and/or present holographic or other visual representations. The output 815 may be configured to audibly present information, and it may include suitable components for receiving and presenting audio signals. Although FIG. 8 illustrates a single output 815, the server 810 may include any number of similar or different output devices.

The input 817 may include components such as a keyboard, a mouse, a pointing device, a joystick, and/or a touch screen. The input 817 may also include audio- or video-capture devices (e.g., video cameras, microphones, etc.) and/or various sensors for sensing emissions (e.g., thermal, motion, sound, etc.). It may also include one or more information reading devices (e.g., scanners, disk drives, etc.) and/or input ports. Although FIG. 8 depicts the input 817 as a single discrete element, the server 810 may include any number of similar or different input devices. For example, the server 810 could include a keyboard and a mouse as well as a video-capture device, a scanner and several disk drives.

A user of the server 810 may input commands to control and operate functionality of the server 810 by way of the output 815 and the input 817. These commands may, for example, be input by way of user manipulation of physical controls, such as a keyboard or mouse. The user may input commands to select and manipulate graphics and text objects presented on the output 815 in order to operate and control the server 810.

The interfaces 819 may include various interfaces for facilitating bidirectional or unidirectional communication between the server 810 and one or more peripheral or other devices. The peripheral devices may include, for example, output devices (e.g., a monitor, a printer, a speaker, etc.), input devices (e.g., a keyboard, a mouse, a scanner, etc.), or any other device operable to connect to the server 810. The interfaces 819 may include a combination of hardware, software and/or firmware components. The interfaces 819 may include various connection ports, such as USB, RS-232, RS-485, Fibre Channel, Ethernet, IEEE 1394, RG-6, and/or TOSLINK.

The storage 821 may provide mass storage and/or cache memory for the server 810. The storage 821 may be implemented using a variety of suitable memory elements. The memory elements may include, for example, solid state elements, optical elements, polymer elements, magnetic elements, and/or organic elements (e.g., crystals). The memory elements may be volatile or non-volatile and may be randomly or sequentially accessed. The storage 821 may include random access memory (RAM), flash RAM, read-only memory (ROM), erasable programmable read-only memory (EPROM), and electrically erasable programmable read-only memory (EEPROM). The storage 821 may include one or more fixed disk drives (e.g., a hard drive, RAID storage, etc.) and one or more removable disk drives (e.g., a CD-ROM drive, DVD drive, etc.). Although a single storage module is shown, the server 810 may include any number of individually configured storage modules.

The storage 821 may store program code for various applications, an operating system (e.g., Windows® XP, Linux® OS), an application-programming interface, application routines, middleware components, and/or other executable instructions. The storage 821 may include program code and information for communications (e.g., TCP/IP communications), middleware components, kernel and device drivers, invariant low-level systems code, data for basic input and output, and various configuration information.

The storage 821 may maintain an application layer 823, which may include various software programs and modules. Such programs and modules could be transferred to a hard drive (not shown) in the storage 821 by way of network transmissions (e.g., an Internet download) and/or removable disks (also not shown), such as a CD-ROM or DVD.

In the configuration 800, the server 810 may be coupled to one or more repositories 825. In some examples, the repositories 124, 126, 136 and 146 may be implemented in a manner consistent with the repositories 825. The repository 825 may include any structured collection or aggregation of information that is stored and accessible. In some implementations, the repositories 825 may include one or more structured data archives distributed among one or more network-based data processing systems. The repositories 825 may include one or more schemas for organizing stored information. In some examples, the repositories 825 may include one or more relational databases and systems, distributed databases, object-oriented databases, and/or any other types of databases. Examples of databases include Oracle® databases, IBM DB2 systems, MySQL® databases, XML databases, and the like. Although illustrated as coupled to the server 810, the repositories 825 could be distributed and/or included in various systems and/or networks.

### Exemplary Application Layer Configuration

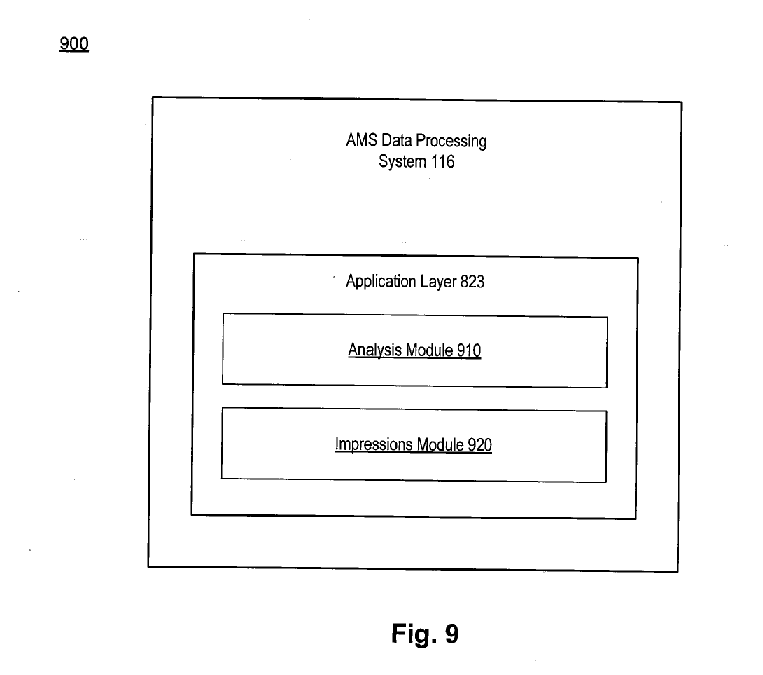

FIG. 9 is a block diagram of an exemplary configuration 900 of the application layer 823, which may be maintained in the storage 821 of the server 810. The configuration 900 may represent the configuration of an application layer of a data processing system (e.g., the system 116) maintained by the AMS 106. As illustrated in FIG. 9, the application layer configuration 900 may include an analysis module 910 and an impressions module 920.

The modules 910 and 920 may include and/or use one more data structures as well as one or more computational algorithms that may operate on various data. The modules may include sets of instructions for performing various tasks, and the modules may output information for use by users or other systems. In some implementations, the modules may include one or more engines, which may output code (e.g., source code, HTML, etc.) that serves as input to other systems, engines or processes.

The modules 910 and 920 may be implemented using any programming or other language suitable for controlling behavior of a system, such as a computer. In some examples, the modules 910 and 920 may be implemented using one or more of C/C++, Java, Visual Basic, eXtendible Markup Language (XML), HTML and other languages.

Although depicted within software application layer 823, the modules 910 and 920 could include and/or be coupled to various hardware elements (within or external to the server 810). For example, the modules could include one or more neural networks, which may employ software and hardware processing elements or agents linked together. In some examples, the modules could include or use one more embedded systems, such as microcontrollers, routers, etc.

The analysis module 910 may be configured to perform various analyses and operations, such as retrieving advertisements relevant to requested content and user interests. The analysis module 910 may also be configured to determine user attention to ads and effect modifications to ad presentations. In some examples, the analysis module 910 may store and/or execute the operations consistent with the processes 400, 500 and 600 depicted in FIGS. 4-6.

The impressions module 920 may be configured to perform various actions related to detecting and reporting impressions of ads. The impressions module 920 may store and/or execute operations consistent with the process 700 illustrated in FIG. 7. In some examples, the impressions module 920 and the analysis module 910 may interact. For example, the impressions module 920 could send impressions data to the analysis module 910 for analysis. Likewise, the analysis module 910 could send analysis information to the impressions module 920.

### Exemplary User Access Device Configuration

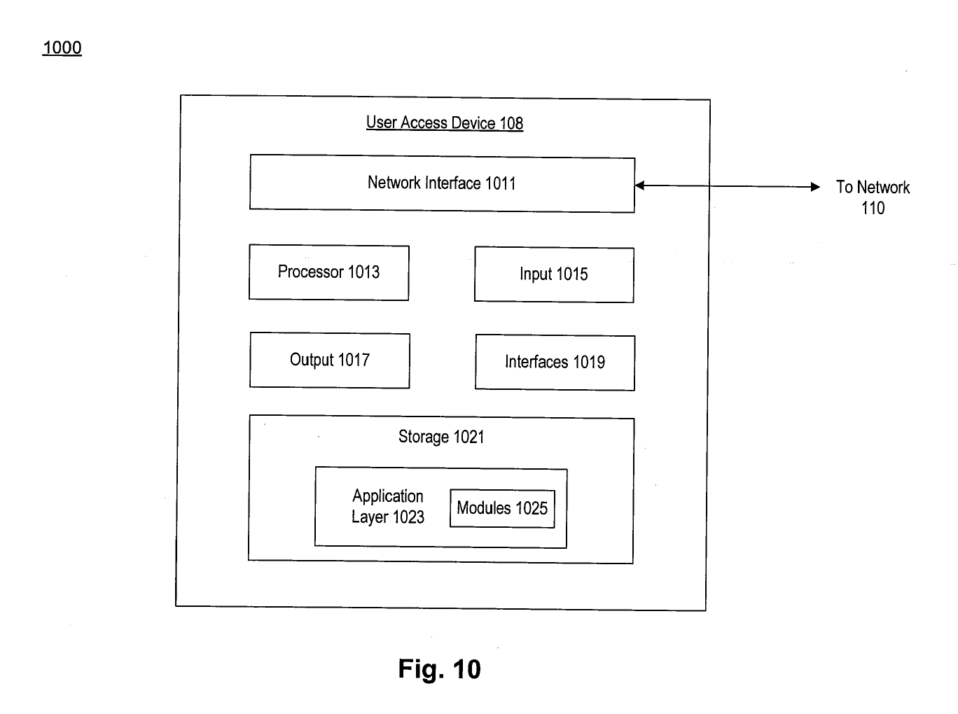

FIG. 10 is a block diagram of an exemplary configuration 1000 of the user access devices 108 in environment 100. The number, identity and arrangement of elements in the configuration 1000 are not limited to what is shown, and additional and/or different elements may be contained in or coupled to the elements shown. The configuration 1000 is exemplary only, and the user access device 108 could be configured in other ways.

In the exemplary configuration 1000, the user access devices 108 may include various components, such as a network interface 1011, a processor 1013, an output 1015, an input 1017, interfaces 1019, and a storage 1021, which may maintain an application layer 1023. The components illustrated in FIG. 10 (i.e., 1011, 1013, 1015, 1017, 1019, 1021, and 1023) may be similar in structure and functionality to those components described in connection with FIG. 8 (i.e., 811, 813, 815, 817, 819, 821, and 823). In some implementations, however, one or more of the user access devices 108 may include components that are structurally and functionally different from those described in connection with FIG. 8. For example, the user access devices 108 may be configured with different (e.g., less) storage capacity and different application layers than the server system. In some examples, the application layer 1023 in a user access device may include one or more modules configured to present various viewers (e.g., browsers) to users. The application layer 1023 may also include one or more modules (e.g., modules 1025) for interacting with other elements (e.g., data processing systems 112, 114 and/or 116), receiving and processing ads, and/or combining received ads with received content for presentation to users.

The user access devices 108 could also be configured with less or different processing capabilities than that of the server system. In some examples, the user access devices 108 may include various user interface components (e.g., keypads, display devices, speakers, microphones, etc.) while the server system may lack such (or even any) user interface components. In some examples, the server system 810 could be a general purpose server while the user access devices 108 could include embedded systems optimized with specific components for performing specific tasks.

The foregoing description does not represent an exhaustive list of all possible implementations consistent with this disclosure or of all possible variations of the implementations described. Other implementations are within the scope of the following claims.

1. A computer-implemented method, comprising:
generating, by a server device, an advertisement presentation for display on a web page, the advertisement presentation comprising a first advertisement associated with an advertiser;
providing, by the server device to a client device, the advertisement presentation to be displayed on the web page;
receiving, by the server device from the client device, user activity indicating that the user interacted with the first advertisement;
identifying, by the server device, one or more second different advertisements related to a same topic as the first advertisement;
comparing an amount of time the user spent performing the user activity with a threshold value to determine a level of the user satisfaction;
when the user satisfaction is at a first level:
generating, by the server device and based on the first level, a first modified advertisement presentation of the first advertisement that is modified to include a selectable link that navigates the user to a landing page different from the web page that presents the one or more second different advertisements related to a same topic as the first advertisement;
providing, by the server device to the client device, the first modified advertisement presentation of the first advertisement; and
causing the first modified advertisement presentation to be displayed on the web page; and
when the user satisfaction is at a second level that is different from and lower than the first level:
generating, by the server device and based on the second level that is different from and lower than the first level, a second modified advertisement presentation of the first advertisement that is different from the first modified advertisement presentation, and is modified to include a user interface element that scrolls through multiple different advertisements while the web page is displayed;
providing, by the server device to the client device, the second modified advertisement presentation of the first advertisement; and
causing the second modified advertisement presentation to be displayed on the web page.

2. The method of claim 1, wherein the advertisement presentation is presented on a portion of the web page.

3-4. (canceled)

5. The method of claim 1, wherein:
determining the amount of time the user spent performing the user activity comprises determining an amount of time a user views a landing page associated with the first advertisement; and
determining the user satisfaction with the first advertisement comprises comparing the determined amount of time with a threshold value.

6-7. (canceled)

8. The method of claim 1, wherein:
generating the first modified advertisement presentation comprises:
determining a location of the landing page comprising the one or more second advertisements that are related to the first advertisement included in the advertisement presentation, and
modifying the advertisement presentation previously provided to the client device to include the selectable link indicative of a type of advertisement of the one or more second advertisements that are related to the first advertisement;
providing, by the server device to the client device, the first modified advertisement presentation comprises providing the selectable link indicative of the type of advertisement of the one or more second advertisements;
generating the second modified advertisement presentation comprises modifying the advertisement presentation previously provided to the client device to include the one or more second advertisements and the user interface element that allows the user to scroll through the one or more second advertisements; and
providing, by the server device to the client device, the second modified advertisement presentation comprises providing the one or more second advertisements and the user interface element that allows the user to scroll through the one or more second advertisements.

9. The method of claim 8, wherein
the landing page is maintained by an entity other than the advertiser.

10. The method of claim 1, further comprising:
generating a descriptor that summarizes content requested by a user;
associating the generated descriptor with a link in the advertisement presentation; and
providing the descriptor to the client device, wherein the advertisement presentation is modified to include the descriptor.

11. The method of claim 10, wherein generating a descriptor comprises generating a phrase of one or more words that summarizes the requested content.

12. A system comprising:
one or more computers; and
a computer-readable medium coupled to the one or more computers having instructions stored thereon which, when executed by the one or more computers, cause the one or more computers to perform operations comprising:
generating an advertisement presentation for display on a web page, the advertisement presentation comprising a first advertisement associated with an advertiser;
providing, to a client device, the advertisement presentation to be displayed on the web page;
receiving, from the client device, user activity indicating that the user interacted with the first advertisement;
identifying one or more second different advertisements related to a same topic as the first advertisement;
comparing an amount of time the user spent performing the user activity with a threshold value to determine a level of user satisfaction;
when the user satisfaction is at a first level:
generating, based on the first level, a first modified advertisement presentation of the first advertisement that is modified to include a selectable link that navigates the user to a landing page different from the web page that presents the one or more second different advertisements related to a same topic as the first advertisement;
providing, to the client device, the first modified advertisement presentation of the first advertisement; and
causing the first modified advertisement presentation to be displayed on the web page; and
when the user satisfaction is at a second level that is different from and lower than the first level:
generating, based on the second level that is different from and lower than the first level, a second modified advertisement presentation of the first advertisement that is different from the first modified advertisement presentation, and is modified to include a user interface element that scrolls through multiple different advertisements while the web page is displayed;
providing, to the client device, the second modified advertisement presentation of the first advertisement; and
causing the second modified advertisement presentation to be displayed on the web page.

13. The system of claim 12, wherein the operations further comprise presenting the advertisement presentation on a portion of the web page.

14-15. (canceled)

16. The system of claim 12, wherein:
determining the amount of time the user spent performing the user activity comprises determining an amount of time a user views a landing page associated with the first advertisement; and
determining the user satisfaction with the first advertisement comprises comparing the determined amount of time with a threshold value.

17-18. (canceled)

19. The system of claim 12, wherein the operations further comprise:
generating one or more words that summarize content requested by a user;
associating the one or more words with the selectable link in the advertisement presentation; and
modifying the advertisement presentation to include the one or more words.

20. (canceled)

21. A computer storage medium encoded with a computer program, the computer program comprising instructions that, when executed by one or more computers, cause the one or more computers to perform operations comprising:
generating an advertisement presentation for display on a web page, the advertisement presentation comprising a first advertisement associated with an advertiser;
providing, to a client device, the advertisement presentation to be displayed on the web page;
receiving, from the client device, user activity indicating that the user interacted with the first advertisement;
identifying one or more second different advertisements related to a same topic as the first advertisement;
comparing an amount of time the user spent performing the user activity with a threshold value to determine a level of user satisfaction;
when the user satisfaction is at a first level:
generating, based on the first level, a first modified advertisement presentation of the first advertisement that is modified to include a selectable link that navigates the user to a landing page different from the web page that presents the one or more second different advertisements related to a same topic as the first advertisement;
providing, to the client device, the first modified advertisement presentation of the first advertisement; and
causing the first modified advertisement presentation to be displayed on the web page; and
when the user satisfaction is at a second level that is different from and lower than the first level:
generating, based on the second level that is different from and lower than the first level, a second modified advertisement presentation of the first advertisement that is different from the first modified advertisement presentation, and is modified to include a user interface element that scrolls through multiple different advertisements while the web page is displayed;
providing, to the client device, the second modified advertisement presentation of the first advertisement; and
causing the second modified advertisement presentation to be displayed on the web page.

22-30. (canceled)

31. The method of claim 1, further comprising:
detecting ad impressions associated with each of the one or more second advertisements; and
providing a report of the ad impressions to at least one of a publisher associated with the web page or a respective advertiser associated with each of the one or more second advertisements.

32-36. (canceled)

37. The method of claim 1, further comprising:
causing a display of the first or second modified advertisement presentation, following a return to the web page.

38. The system of claim 12, wherein:
generating the first modified advertisement presentation comprises:
determining a location of the landing page comprising the one or more second advertisements that are related to the first advertisement included in the advertisement presentation, and
modifying the advertisement presentation previously provided to the client device to include the selectable link indicative of a type of advertisement of the one or more second advertisements that are related to the first advertisement;
providing, by the server device to the client device, the first modified advertisement presentation comprises providing the selectable link indicative of the type of advertisement of the one or more second advertisements;
generating the second modified advertisement presentation comprises modifying the advertisement presentation previously provided to the client device to include the one or more second advertisements and the user interface element that allows the user to scroll through the one or more second advertisements; and
providing, by the server device to the client device, the second modified advertisement presentation comprises providing the one or more second advertisements and the user interface element that allows the user to scroll through the one or more second advertisements.

39. The computer storage medium of claim 21, wherein:
generating the first modified advertisement presentation comprises:
determining a location of the landing page comprising the one or more second advertisements that are related to the first advertisement included in the advertisement presentation, and
modifying the advertisement presentation previously provided to the client device to include the selectable link indicative of a type of advertisement of the one or more second advertisements that are related to the first advertisement;
providing, by the server device to the client device, the first modified advertisement presentation comprises providing the selectable link indicative of the type of advertisement of the one or more second advertisements;
generating the second modified advertisement presentation comprises modifying the advertisement presentation previously provided to the client device to include the one or more second advertisements and the user interface element that allows the user to scroll through the one or more second advertisements; and
providing, by the server device to the client device, the second modified advertisement presentation comprises providing the one or more second advertisements and the user interface element that allows the user to scroll through the one or more second advertisements.
